(19) United States
(12) Patent Application Publication
(10) Pub. No.: US 2005/0051674 A1
(43) Pub. Date: Mar. 10, 2005

(54) Pipe surge protector and hanger support

(76) Inventors: Winston Breeden JR., Wakeman, OH (US); E. Scot Kennedy, Akron, OH (US)

Correspondence Address: PEARNE & GORDON LLP, 1801 EAST 9TH STREET, SUITE 1200, CLEVELAND, OH, 44114-3108, US

(21) Appl. No.: 10/659,604

(22) Filed: Sep. 10, 2003

(51) Int. Cl. F16L 3/22

(52) U.S. Cl. 248/68.1

(57) ABSTRACT

A device for supporting a pipe hanger from a support member and for preventing a pipe in the pipe hanger from contacting the support member due to a force exerted on the pipe by a fluid therein. The device includes a connector for coupling the pipe surge restrainer to the support member and for supporting the pipe hanger; a plurality of arms extending from the connector and spaced to permit location of the support member there between when the device is adjusted so that the support member projects beyond the connector; and a portion joining ends of the arms distal from the connector, the portion for location between the pipe and the support member to prevent the pipe from contacting the support member. The present invention further includes a pipe support assembly with the device described above.

### FIELD OF THE INVENTION

The present invention is directed in general to the suspension of a pipe from a structure, and more particularly to a device for supporting a hanger for suspending a pipe and preventing damage to the pipe in the event that the pipe surges due to a force exerted on the pipe by a fluid therein.

### BACKGROUND OF THE INVENTION

Fire extinguishing systems are required in many enclosed structures due to Federal, State and/or local laws. For example, the Hotel and Motel Fire Safety Act of 1990 requires automatic sprinkler systems to be installed in each place of public accommodation affecting commerce except those places that are three (3) stories or lower. By definition, automatic sprinkler systems include an integrated system of piping to which sprinklers are systematically attached that will discharge water over an area being consumed by a fire. Typically, provision of this type of automatic sprinkler system has been accomplished by suspending the piping network with sprinklers from an overhead structure such as a ceiling. When a fire is detected, the appropriate portions of the automatic sprinkler system adjacent to the fire are activated to discharge water in a generally horizontal pattern away from the sprinkler, allowing gravity to direct the discharged water downward onto the fire.

Due to the large areas often protected by these fire extinguishing systems, several sprinklers must be attached to a series connection of the piping system. When the fire extinguishing system is activated, the water pressure at each sprinkler located away from the water source is less than the water pressure at a preceding sprinkler. However, a lower threshold amount of water pressure must be maintained in the automated sprinkler system to ensure a sufficient delivery of water to even the furthest sprinkler to combat fires engulfing large areas of a structure. Thus, pipes in a fire extinguishing system must be strong enough to withstand large pressures therein.

Typically, fluid carrying pipes are suspended from an overhead structure by a pipe support assembly. Such assemblies include a strap in a shape suitable for cradling a pipe therein, the strap further including overlapping ends that engage a support member attached to the overhead structure. When installed, the pipe, in its resting position, rests on the strap between the strap and the support member.

When an outlet in the pipe is suddenly opened, such as when the fire extinguishing system is activated in the presence of a fire, pressurized liquid is forced from the outlet and the interior of the pipe experiences a sudden pressure gradient and nominal pressure drop. This pressure change creates forces on the pipe which, if large enough, cause the pipe to move away from a resting position in a pipe support assembly. This movement, commonly called pipe surge, is often violent enough to cause the pipe to contact the support member. Pipes made from materials that can not withstand such contact are bent or punctured.

Until the development of high strength composite materials, the pipes in fire extinguishing systems were commonly manufactured from metals, such as steel, for example. Steel pipes could withstand high pressures commonly experienced in fire extinguishing systems, resist damage when pipe surge occurred, and would not fail when subjected to the high temperature conditions encountered in a fire. However, steel pipes are expensive to install throughout large fire extinguishing systems, and they are heavy and difficult to install.

The use of a chlorinated polyvinyl chloride (“CPVC”) compound in the construct of pipes used in fire extinguishing systems is now well known. It provides a cost-effective alternative to metallic pipes for fire extinguishing systems, does not burn, and requires minimal labor to install. However, pipes made from CPVC compounds are more susceptible to damage from pipe surge and may be punctured if subjected to violent pipe surge.

Known methods of protecting pipes in a pipe support assembly include the use of so called tear-drop shaped straps. Such straps have overlapping ends forming a common aperture through which the support member passes. The lower, or saddle, portion of the strap is sufficiently sized to permit the pipe to rest therein. Adjacent to the point of contact between the support member and the ends of the strap, the ends form a generally triangular shaped structure. The angled ends of the strap form a narrow passage that inhibits movement of the pipe towards the support member. However, sufficiently violent pipe surges will force the pipe away from its resting position in the saddle portion, bend the ends of the strap forming the angled walls of the triangle, and cause contact between the pipe and the support member. Also, if the pipe being supported by the tear-drop shaped strap is replaced with a smaller diameter pipe, the angled side walls formed by the ends of the strap may not interfere with a surge of the pipe before the pipe makes contact with the support member. Further, many pipe support assemblies already in use include the tear-drop shaped straps to support pipes, and it would be expensive to replace them with new pipe support assemblies.

To overcome the shortcomings of tear-drop shaped straps, clip on surge restrainers have been developed. Clip on surge restrainers releasably engage a connector that couples a support strap to a support member. Arms of such surge restrainers grip an exposed portion of the connector and support a flat portion of the surge restrainer between the support member and a pipe in the pipe support assembly. However, when the arms of this type of surge restrainer are in communication with the exposed portion of the connector, manual adjustment of the connector position along the support member is not possible without removing the clip on surge restrainer. This removable quality of the clip on surge restrainer creates the possibility that reinstallation of the clip on surge restrainer will be overlooked after adjustment of the connector position. The clip on surge restrainer is also easily misplaced when uninstalled, leaving the support member exposed to potentially damage the pipe in the event of pipe surge.

It would be beneficial to provide a low-cost apparatus and method for preventing contact between a support member and a pipe being supported by the support member. The apparatus should be installed to protect a wide variety of pipe dampers without a significant amount of labor. Additionally, there is a need for a device that is compatible to be retro-fit with pipe support assemblies already in use to minimize the amount of cost and waste incurred in protecting pipes supported by conventional pipe support assemblies.

### SUMMARY OF THE INVENTION

In accordance with one aspect, the present invention provides a device for supporting a pipe hanger from a support member and for preventing a pipe in the pipe hanger from contacting the support member due to a force exerted on the pipe by a fluid therein. The device includes a connector for coupling the pipe surge restrainer to the support member and for supporting the pipe hanger, a plurality of arms extending from the connector and spaced to permit location of the support member there between when the device is adjusted so that the support member projects beyond the connector, and a portion joining ends of the arms distal from the connector, the portion for location between the pipe and the support member to prevent the pipe from contacting the support member.

In accordance with another aspect, the present invention also provides a pipe support assembly for suspending a pipe from a support member in a manner to prevent contact between the pipe and the support member due to a force exerted on the pipe by a fluid therein. The pipe support assembly includes a pipe hanger and a device for supporting the pipe hanger from the support member and for preventing the pipe from contacting the support member. The device includes a connector to connect the device to the support member; a plurality of arms extending from the connector and spaced to permit location of the support member there between when the device is adjusted so that the support member projects beyond the connector, and a portion joining ends of the arms distal from the connector, the portion for location between the pipe and the support member to prevent the pipe from contacting the support member. The pipe hanger is shaped to support the pipe, the pipe hanger having an upper end including a hole sized to extend about the connector is vertically supported by the collar.

### BRIEF DESCRIPTION OF THE DRAWINGS

The foregoing and other features and advantages of the present invention will become apparent to those skilled in the art to which the present invention relates upon reading the following description with reference to the accompanying drawing, in which:

FIG. 1 is an illustrative view of an example arrangement of a pipe support assembly in accordance with the present invention suspended from an overhead structure, the pipe supported therein being shown in phantom; and

FIG. 2 is a schematic representation of an end of a pipe surge restrainer in accordance with one embodiment of the present invention.

### DETAILED DESCRIPTION OF AN EXAMPLE EMBODIMENT

Certain terminology is used herein for convenience only and is not to be taken as a limitation on the present invention. Further, in the drawings, certain features may be shown in somewhat schematic form.

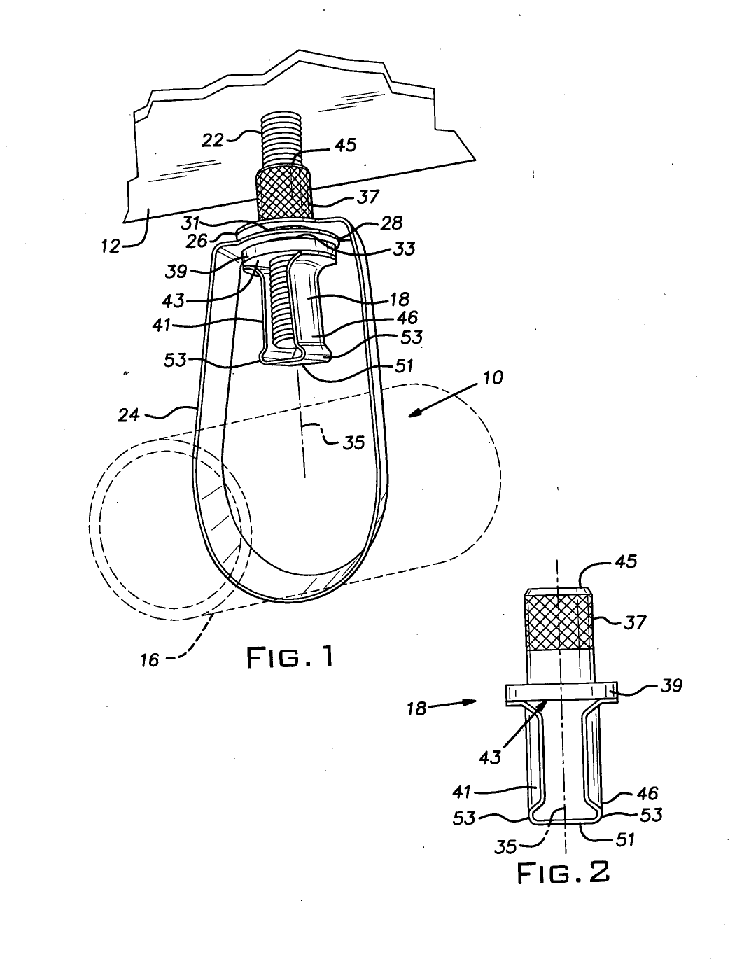

An example of a pipe support assembly 10 suspended from an overhead structure 12 is shown in FIG. 1. Common overhead structures 12 include objects such as ceilings, support beams, or any other object found adjacent an upper portion of a sheltered area that is capable of supporting a fluid carrying pipe 16. The pipe support assembly 10 includes a surge restrainer 18 releasably coupled to a support member 22 in a position to limit movement of the pipe 16 away from a resting position in a hanger 24.

The hanger 24 includes a length of preferably durable material having a first end 26 and a second end 28, each of the first and second ends 26, 28 having an aperture 31, 33. The material selected for the hanger 24, and the remaining features of the present invention, should possess enhanced resistance to damage from high temperatures, and be suitably strong to minimize the possibility of an unexpected loss of support for the pipe 16. Forming the hanger 24, the length of material is shaped such that the first end 26 and the second end 28 overlap each other and the apertures 31, 33 share a generally common central axis 35. Once formed, the hanger 24 is shaped like a generally oblong enclosure that conforms to, and encircles a potion of the pipe 16 when the pipe support assembly is suspended to support the pipe 16. In the resting position, the pipe 16 is being supported by the hanger 24 in an undisturbed state where no external forces from the fluid are acting on the pipe.

Although the hanger 24 is described above as a length of material with an aperture 31, 33 located in each of two ends 26, 28, the present invention contemplates the use of a hanger 24 formed as a continuous piece. Thus, there are no overlapping ends with apertures that are generally coaxial. Instead, the hanger 24 includes a single, continuous piece of material with a single aperture (not shown) for coaxial alignment with the axis 35.

When installed, the support member 22 extends from the overhead structure 12 from which the pipe support assembly 10 is suspended. Any structure capable of communicating with the overhead structure 12 at one end and a compatible feature of the surge restrainer 18 on the other, will suffice as the support member 22. According to an embodiment shown in the Figures, the support member 22 of the present invention includes an externally threaded, elongated rod extending from the overhead structure 12 for communication with an internally threaded portion (not shown) within a connector 37 of the surge restrainer 18. In accordance with this embodiment, the support member 22 and the surge restrainer 18 are generally coaxial along the axis 35 when those two features are in threaded communication. The position of the surge restrainer 18 relative to the support member 22 is adjustable, according to this embodiment, by engaging a griping feature 38 (illustrated as intersecting hatching lines in FIGS. 1 and 2) and rotating the connector 37 about the support member 22.

Although the description of the first embodiment above includes an externally threaded support member 22 and an internally threaded portion located within the connector 37, the scope of the present invention includes an internally threaded socket (not shown) disposed within the support member 22 for communication with an externally threaded projection (not shown) extending from the connector 37.

The surge restrainer 18 according to the present invention includes the connector 37 having a generally circular collar 39 adjacent to a lower end of the connector 37. The diameter of the outer edge of the collar is suitably sized to prevent the collar 39 from passing through the apertures 31, 33 in the hanger 24, and the collar 39 supports the hanger. A plurality of arms 41 extend axially away from the connector 37 in a direction generally parallel to the central axis 35 commonly shared by the support member 22 and the apertures 31, 33 in the first and second ends 26, 28 when the pipe support assembly 10 is assembled and suspended from the overhead structure 12. Distal ends 46 of the arms 41 are joined by a joining portion 47 adapted to limit movement of the pipe 16 without damaging the pipe 16 in the event of a disruption that causes the pipe 16 to move away from its resting position. Damage prevention may be effected in one or more different manners. For example, the area of the joining portion 47 is greater than the area at the bottom of the support member 22. As a feature of an embodiment of the present invention, the joining portion 47 includes a generally flat surface over which the force of an impact between the pipe and the joining portion 47 is dissipated without damaging the pipe 16.

In addition to having distal ends joined by the portion 47, the arms 41 are spaced to permit location of the support member 22 in the space defined by the arms 41 when the surge restrainer 18 is adjusted so that the support member 22 projects beyond the connector 37. Adjusting the position of the surge restrainer 18 on the threaded support member 22, for example, will cause the support member 22 to pass through the compatibly threaded connector 37. If the position of the surge restrainer 18 relative to the support member 22 is adjusted such that the distance between the surge restrainer 18 and the overhead structure 12 is minimized, the maximum length of the support member 22 is extended beyond the connector 37. In this position, an extended end 49 of the support member 22 contacts the joining portion 47. From this position, the surge restrainer 18 may be adjusted relative to the threaded member 22 to maximize the distance between the extended end 49 of the support member 22 and the joining portion 47. Adjustment of the surge restrainer 18 in this relative direction may continue until the surge restrainer 18 loses communication with the support member 22, at which time the surge restrainer 18 is separated from the support member 22, and accordingly, the pipe support assembly 10.

The apertures 31, 33 in the first and second ends 26, 28 and the connector 39 are suitably sized to allow the connector 37 to pass through the apertures 31, 33. The location of the collar 39 on the connector 37 limits the length of the connector 37 that may pass through the apertures 31, 33. Another feature of the present invention, best shown in FIG. 1, is the collar 39 located adjacent to a lower end 43 of the connector 37. When the pipe support assembly 10 is installed, the upper end 45 of the connector 37 is inserted through the apertures 31, 33 in a generally vertical upward direction toward the support member 22 extending from the overhead structure 12. The remainder of the connector 37 is extended through the apertures 31, 33 until the collar 39 makes contact with the first end 26 or the second end 28. Extending the connector 37 through the apertures 31, 33 is limited by contact between the collar 39 and either the first end 26 or the second end 28 because the two ends 26, 28 are overlapped, and thus, contact with only one of the ends 26, 28 and the collar 39 is possible according to this embodiment. The end of the hanger 24 that is not in contact with the collar 39 is separated from the collar 39 by the end of the hanger 24 that is in contact with the collar 39. Despite the end of the hanger 24 that is in contact with the collar 39, the size of the collar 39 prevents the apertures 31, 33 in the hanger 24 from passing over the collar 39 and provides vertical support for the hanger 24 by allowing portions of the hanger 24 defining the apertures 31, 33 to rest on the collar 39.

According to the embodiment described above, the arms 41 are formed at a side of the collar 39 that is opposite of a side that is in contact with the end of the hanger 24. The arms extend away from the connector in a direction that is generally parallel to the axis 35. However, the scope of the present invention includes a device with the connector 37 extending generally downwardly from the collar 37 and the arms 41 attached to, and extending from, the lower end 43 of the connector 37.

The scope of the present invention further includes location of the collar 39 at a position along the connector 37 between the two ends 43, 45. Just as before, vertical translation of the ends 26, 28 of the hanger 24 over the connector 37 is limited in one direction by the collar 39. The apertures 31, 33 in the hanger 24 encircle the connector 37, allowing a portion of the connector 37 to pass therethrough. When the pipe support assembly 10 is assembled, the hanger 24 to rest atop the collar 39. Once again, through this arrangement, vertical support for the hanger 24 on the pipe support assembly 10 is provided by contact between the portion of the hanger 24 defining the apertures 31, 33 and the collar 39.

The joining portion 47 adapted to be located between the pipe 16 supported by the hanger 24 and the support member 22 joins distal ends 49 of the arms 41. A contacting surface 51 of the joining portion 47 is suitably shaped to contact the pipe 16 without damaging it in the event of a disruption that causes the pipe 16 to move away from its resting position. As shown in the figures, the joining portion 47 is generally flat, having arcuate portions 53 in communication with the distal ends 49 of the arms 41. However, it will be appreciated that the joining portion 47 may include an arcuate contacting surface 51 that generally conforms to a cylindrical pipe 16 and other geometrically shaped portions supplanting the arcuate portions 53.

In use, the support member 22 is suspended from the overhead structure 12. The support member 22 receives the surge restrainer 18 extending through the apertures 31, 33 in the overlapping ends 26, 28 of the hanger 24, the hanger 24 being shaped to support the pipe 16. Adjusting the position of the surge restrainer 18 relative to the support member 22 allows generally coaxial installation of a plurality of pipe support assemblies 10 to support the pipe 16, or a network of pipes 16, at a predetermined altitude. If pipe surge occurs, the pipe 16 supported by the pipe support assembly 10 will move away from the resting position in the hanger 24 and contact the joining portion 47 of the surge restrainer 18, thereby preventing the pipe 16 from contacting the support member 22.

From the above description of the invention, those skilled in the art will perceive improvements, changes and modifications. Such improvements, changes and modifications within the skill of the art are intended to be covered by the appended claims.

1. A device for supporting a pipe hanger from a support member and for preventing a pipe in the pipe hanger from contacting the support member due to a force exerted on the pipe by a fluid therein, the device including:
a connector for coupling the pipe surge restrainer to the support member and for supporting the pipe hanger;
a plurality of arms extending from the connector and spaced to permit location of the support member there between when the device is adjusted so that the support member projects beyond the connector; and
a portion joining ends of the arms distal from the connector, the portion for location between the pipe and the support member to prevent the pipe from contacting the support member.

2. The device according to claim 1, wherein the connector includes a threaded portion for communication with a compatible threaded portion of the support member.

3. The device according to claim 1, wherein the connector has a collar for supporting the pipe hanger, the collar being a circular member integrally formed on the connector.

4. The device according to claim 3, wherein the collar is at a lower end of the connector.

5. The device according to claim 1, wherein the arms and the portion joining the distal ends of the arms are formed from a single metal piece that is bent into shape.

6. The device according to claim 1, wherein ends of the arms are welded to the connector at locations allowing for the formation of a space between the arms to permit location of the support member there between when the device is adjusted so that the support member projects beyond the connector.

7. The device according to claim 1, wherein the portion joining the distal ends of the arms forms a smooth contacting surface including an arcuate portion disposed at an interface between the contacting surface and the arms.

8. The device according to claim 1, wherein the connector further includes a gripping feature disposed on an outer surface of the connector, the gripping feature for facilitating adjustment of the position of the device relative to the support member.

9. A pipe support assembly for suspending a pipe from a support member in a manner to prevent contact between the pipe and the support member due to a force exerted on the pipe by a fluid therein, the pipe support assembly including:
a pipe hanger; and
a device for supporting the pipe hanger from the support member and for preventing the pipe from contacting the support member, the device including:
a connector to connect the device to the support member;
a plurality of arms extending from the connector and spaced to permit location of the support member there between when the device is adjusted so that the support member projects beyond the connector; and
a portion joining ends of the arms distal from the connector, the portion for location between the pipe and the support member to prevent the pipe from contacting the support member; wherein,
the pipe hanger is shaped to support the pipe, the pipe hanger having an upper end including a hole sized to extend about the connector is vertically supported by the collar.

10. The pipe support assembly according to claim 9, wherein the pipe hanger is formed from a flat piece of metal formed into a suitable shape.

11. The pipe support assembly according to claim 10, wherein the pipe hanger further includes an aperture in each of a first end and a second end, the apertures for location about the support member.

12. The pipe support assembly according to claim 9, wherein the position of the pipe hanger relative to the device is limited in one direction by contact between a collar disposed at an end of the connector and the upper end of the pipe hanger.

13. The pipe support assembly according to claim 9, wherein the portion joining distal ends of the arms forms a smooth contacting surface including an arcuate portion disposed at an interface between the contacting surface and the arms.
